(19) United States
(12) Patent Application Publication
(10) Pub. No.: US 2003/0027002 A1
(43) Pub. Date: Feb. 6, 2003

(54) System and methods for filtering electromagnetic visual, and minimizing acoustic transmissions

(76) Inventors: Deron Simpson, Finksburg, MD (US); Lisa Winckler, Collinsville, VA (US)

Correspondence Address: HOGAN & HARTSON LLP, IP GROUP, COLUMBIA SQUARE, 555 THIRTEENTH STREET, N.W., WASHINGTON, DC, 20004, US

(21) Appl. No.: 10/137,313

(22) Filed: May 3, 2002

Related U.S. Application Data
(60) Provisional application No. 60/288,093, filed on May 3, 2001.

(51) Int. Cl. B32B 17/06

(52) U.S. Cl. 428/437; 428/426

(57) ABSTRACT

The invention describes a system and methods for filtering electromagnetic, visual, and minimizing acoustic transmissions. In particular, the anti-surveillance security system of the present invention can be readily configured by connecting a combination of filters to a transparent substrate, whereby the system has a shielding effectiveness_between 22 db-40 db in the frequency range of 30 megahertz-3 gigahertz, an IR transmission at wavelengths between 780 nm and 2500 nm of no more than 50%, and a light transmission less than 1% for wavelengths up to 450 nm.

### CROSS-REFERENCE TO RELATED APPLICATIONS

This application claims priority from U.S. Provisional Patent Application Ser. No. 60/288,093, filed on May 3, 2001, entitled “System and methods for Filtering Electromagnetic, Visual, and Acoustic Transmissions from a Building.”

### BACKGROUND OF THE INVENTION

1. Field of the Invention

The invention relates to a system and methods for filtering electromagnetic, visual, and minimizing acoustic transmissions. More specifically, the invention provides a system and methods to prevent unauthorized data collection and information exchange from or within buildings (such as through windows, doorways, other fenestration, or openings) or otherwise prevent such unauthorized data collection and information exchange from, for example, computer monitors or screens, personal digital assistants, and local area networks.

2. Discussion of Related Art

Electromagnetic radiation of various frequencies is radiated from many devices used in a wide range of facilities including homes, workplaces such as offices, manufacturing and military installations, ships, aircraft and other structures. Examples of such devices include computers, computer monitors, computer keyboards, radio equipment, communication devices, etc. If this radiation escapes from the facility, it can be intercepted and analyzed for the purpose of deciphering data associated with or encoded in the escaped radiation. For example, technology exists for reconstructing the image appearing on a computer monitor in a building from a remote location outside the building or from a location within a building by detecting certain wavelength frequencies from the monitor screen even if the monitor screen is not in view from the remote location. This is accomplished by known techniques wherein certain frequencies of light from the monitor screen, even after being reflected from various surfaces inside the building or room where the monitor is located, escape and are intercepted and analyzed by an eavesdropper in another location outside the building or room where the monitor is located. Obviously, the ability of an eavesdropper to intercept such radiation constitutes a significant security risk, which is desirably eliminated from facilities where secrecy is essential.

Although walls, such as brick, masonry block or stone walls may effectively prevent the escape of light frequencies from a facility, radio frequencies pass through walls that are not properly grounded to prevent such passage. Moreover, windows or other openings allow the passage of radiation to the outside where it can be intercepted, and permit entry of various forms of radiation, such as laser beams, infrared, and radio frequencies, into the facility. As a result, sensitive or secret data may be gathered from within the structure.

The elimination of windows and other openings from a structure would obviously minimize the above-noted security risk. The disadvantages of a windowless or enclosed structure, however, are self-evident. It would be highly desirable, therefore, to prevent the escape of radiation associated with data through windows, doorways, or other openings while allowing other radiation to pass there-through so that the enjoyment of the visual effects provided by such openings can be obtained without an undue security risk.

In addition to the security risks associated with the passage of certain wavelengths of electromagnetic radiation, acoustic transmission through a window, door or other opening also poses a security risk. It would be of additional benefit if transmission of both acoustic and the aforementioned electromagnetic radiation through openings could be minimized or avoided while preserving the visual benefits provided thereby.

The need for reducing the undesirable effects of the sun—its heat, excessive energy usage, glare, and ultraviolet (UV) radiation—has led to the development of solar control window films. Solar control window films are thin polyester sheets, which are mounted on the glass windows of buildings and automobiles via an adhesive. It is said that such films are effective in providing comfort, visibility, and increased energy efficiency.

In the current workplace or home environment, however, there is a need for more protection than solar control films can provide. For example, it is important to protect the work product of an individual, business, or other entity from unauthorized data collection through the glass windows or other openings of their offices. The conventional solar control films described above are, for the most part, incapable of rejecting the wide range of frequencies used for such unauthorized data and information exchange.

Given the importance of security in today's competitive marketplace, a system that could preserve the privacy of the workplace is very desirable. Such a system would provide both comfort and security, which in turn can bring about many benefits, including increased productivity and the preservation of confidentiality in both the public and private sectors.

### SUMMARY OF THE INVENTION

Accordingly, the present invention provides a system and methods for filtering electromagnetic, visual, and minimizing acoustic transmissions by using a combination of filters which substantially obviates one or more of the problems due to the limitations and disadvantages of the related art. The invention further provides a system and methods whereby a combination of films has a shielding effectiveness which attenuates the transmission of radio frequency wavelengths there-through and preferably has a shielding effectiveness of 22 db-40 db in the frequency range of 30 megahertz-3 gigahertz; an IR transmission at wavelengths between 780 nm and 2500 nm of no more than 50%, and preferably of less than 20%, and more preferably of about 15%; and reduces the ability of anyone working in the ultraviolet (UV) through to the visible spectrum up to at least 450 nanometers, to penetrate a building or other surface by at least 99%.

To achieve these and other advantages and in accordance with the purpose of the present invention, as embodied and broadly described, the system and methods of the present invention include a combination of electromagnetic radiation filters, such as selective radiation absorbers and/or selective radiation reflectors. These may be part of a window. The system and methods according to the invention have, however, non-exclusionary applications; the invention can be interposed between glass surfaces or applied to every type of glazing. Further, the system and methods according to the invention can be used for free standing product application for computer screens, monitors and other stand-alone devices. The example of windows discussed herein is employed for convenience and is not intended to be limiting as to surface application.

The radiation filters of the combination may be individual or combined layers applied to a window in any sequence so that light, which passes through the window, passes through the radiation filters used in the combination. The radiation filters may be applied on any surface of the glazing (ie., glass or other transparent material used for windows) of the window to form a multilayered structure of the filters on the glazing. It is not essential for all the layers to be contiguous to each other on one surface of the glazing. Instead, the filters may be distributed in any manner over or in the glazing of a window so as to prevent the passage of the wavelengths which would pose a security risk if they were allowed to pass through the window. For example, one filter may be on one surface of a glass pane while the remaining filters may be distributed as a single or multilayer structure on another surface of the glass layer (e., glass pane) or the filters may be distributed on any of the surfaces of a plurality of glass layers of a window (e.g., a multi-glazed window structure such as a double or triple glazed window structure).

In addition, any or all of the filters may be used in conjunction with a conventional glass interlayer such as the glass interlayer used in conventional safety glass which comprises a plastic interlayer such as polyvinylbutyral (PVB) interposed between two glass layers. The filters may be incorporated in, deposited on, or laminated to the interlayer in which case the filters will be within the glazing of the window.

Each filter of the combination of filters is advantageously in the form of an individual layer or coating, but this is not essential. In the case of filters which are absorbers (filters which use a particular dye, metal, metal salt or pigment to absorb a desired wavelength or range of wavelengths), the entire combination of absorbers or a portion of the combination may be in the form of a mixture of dyes, metal, metal salt or pigments in a single layer as a coating or may be incorporated in a component of the window such as in the polyvinylbutyral interlayer used in safety glass or in an adhesive layer used to adhere film, sheets or the like to the glass. It is also possible to incorporate one or more of the absorbers as a mixture in a film or sheet attached to the window or as layers applied to or coated onto a film or sheet.

The film or sheet may be any of the films or sheets used to make conventional solar control films. An example of a film used for this purpose includes, polyethylene terephthalate (PET), but others may be used as well.

When a film or sheet is used in combination with glass, it is not essential for the entire combination of filters to be in or on the film or sheet. For example, one or more filters may be associated with the film or sheet as described above while any remaining filters may be connected to the glass as described above or vice versa. It is also possible to include a layer which comprises a mixture of absorbers with another layer which is a different filter to make the desired combination. For example, two absorbers such as dyes or pigments of the combination may be used as a mixture as two filters of the combination, and another filter of the combination may be in the form of a distinct layer or coating such as a metal reflecting or absorbing layer.

Moreover, it is not essential for the entire combination of filters to be distributed on the same surface. For example, one or more of the filters may be applied to the glazing of a window while remaining filters may be applied to computer screens or monitors, personal digital assistants, or other stand-alone devices.

Any coatings, layers, films, sheets, lamina or the like used in this invention may be applied to a component of the window (e., the glass or interlayer component) by techniques which are conventional and well known to those skilled in the art. For example, metal layers may be applied by conventional sputtering techniques or evaporative coatings techniques. Any of the various layers may be adhered to the glass by means of conventional adhesives.

Although glass is described herein as the typical material which is used to make a window, it is to be understood that other clear or transparent materials which are useful for making windows may be substituted for the glass. For example hard plastics such as polyearbonate, plexiglass, acrylic plastic, etc., may be used as a substitute for the glass.

In view of the above, it will be appreciated by one skilled in the art that the required combination of filters may be associated with the window in any manner or sequence providing they are configured to prevent passage of the critical wavelengths there-through for achieving the above-described security feature. Optionally additional conventional components or layers may be applied to the window to improve the aesthetics and/or visual characteristics of the window or to provide additional solar control, anti-reflection or radiant heat exclusion or safety and security characteristics in accordance with known techniques.

The desired effect of the present invention (ie., filtering the passage of certain wavelengths through the window) can be achieved with any type of light filter or light valve which prevents the passage of the selected wavelengths. Thus, for example, the light filters or light valves used in this invention may be any of the absorbers described above or any other type of light filter or light valve such as a wavelength selective reflective layer or any combination of different types of light filters and light valves. For example, light absorbers may be combined with reflective layers.

It will be appreciated that the filters used in this invention are selective with respect to the wavelengths being filtered and thus the glazing remains sufficiently transparent for use as a window. Sufficient transparency is achieved by allowing visible light transmission of at least 1%, although higher visible light transmission of at least about 25-30% is preferred.

According to one embodiment, the invention uses a combination of filters comprising, in no particular order, a yellow film layer (including the type used to produce stage or drama lighting), a museum-grade film layer, and a tinted film layer (similar to, but not necessarily the same as, the type applied on automotive glass). To achieve the system of the present invention, the film layers may be combined in any order, and in any manner, including being overlaid or mixed.

The combination of filters are advantageously connected to a transparent substrate and are configured so as to exclude the passage of the selected wavelengths there-through, such as by absorption and/or reflection of the selected wavelengths. Thus, uncoated or exposed areas, which would permit the passage of the selected wavelengths, should be avoided.

Although the filters are connected to the substrate, each filter does not have to be directly connected to the substrate. In other words, the connection of a filter layer may be made by connecting the filter layer to another filter layer which was previously connected to the substrate so that one filter layer is connected to the substrate via another filter layer. For example, when two filter layers are located on one side of the substrate, one filter layer is directly connected to the substrate while the other filter layer is connected to the substrate via the first filter layer (ie., indirectly connected). The same applies in instances where more than two filter layers are connected to one side of the substrate. In other words, being connected to the substrate in this invention is intended to cover both direct and indirect connections. Also, when a filter is formed by mixing or impregnating absorbents such as dyes or pigments into a component, the filter comprised of dye and/or pigment is considered in the context of this invention as being connected to the component.

Instead of coating the filter as a layer on the substrate, the filter may be connected to the substrate by a lamination process wherein a previously formed filter layer is laminated onto the substrate either directly or indirectly.

The substrate may be the glazing of the window or may be a flexible transparent sheet (e.g., plastic sheets such as PET) which is then connected to the glazing. A portion of the combination of filters may be connected to the glazing and another portion of the combination of filters may be connected to one or more flexible transparent sheets, which are connected to the glazing.

All of the filters do not have to be applied to a single substance. For example, in a multi-glazed window, the combination of filters may be distributed on one or more of the glass sheets of the glazing either as a coating or layer on the glass and on one or more sheets connected to the glass.

At least one of the filters may be advantageously electrically conductive to inhibit the passage of radio waves through the window.

The substrate may include other conventional solar control elements such as light absorbing layers, anti-reflecting layers, or reflectors thereon.

The system and methods may also be used as a Glass-fragmentation Safety Film and, as such, may be used to minimize flying glass fragments in real world situations. To accomplish this objective the flexible sheet may include one or more layers which inhibit glass fragments from becoming dangerous flying projectiles when the window breaks due to explosion, implosion, or due to force from a projectile.

### BRIEF DESCRIPTION OF THE DRAWINGS

The accompanying drawings, which are included to provide further understanding of the invention and are incorporated in and constitute a part of this specification, illustrate embodiments of the invention and together with the description, serve to explain the principles of the invention.

In the drawings:

FIG. 1 is a graph which shows the light transmission properties of a light filter used in this invention.

FIG. 2 is a graph which shows the light transmission properties (wavelengths from 300-400 nm) of another light filter used in this invention.

FIG. 3 is a cross-sectional view of a combination of three light filters used in the present invention connected to a substrate.

FIG. 4 is a cross-sectional view of an embodiment of the invention wherein two of the light filters of FIG. 3 are connected to one side of the substrate and the third filter of FIG. 3 is attached to another side of the substrate.

FIG. 5 is a cross-sectional view showing an embodiment of the invention which utilizes a double glazed window.

FIG. 6 is a cross-sectional view of an embodiment of the invention which includes a plurality of light filters attached to conventional safety glass.

FIG. 7 is a cross-sectional view of an embodiment of the invention which includes a combination of light filters connected to a flexible transparent substrate.

FIG. 8 is a cross-sectional view which shows an embodiment of the invention which includes a plurality of light filters connected to a transparent plastic sheet which in turn is adhered to the glass of a window.

FIG. 9 is a cross-sectional view of an embodiment of the invention wherein sealant is used to cover any gaps between the edge of a flexible sheet of the invention and a window frame.

### DETAILED DESCRIPTION OF THE INVENTION AND PREFERRED EMBODIMENTS

Reference will now be made in detail to embodiments of the present invention, examples of which are illustrated in the accompanying drawings.

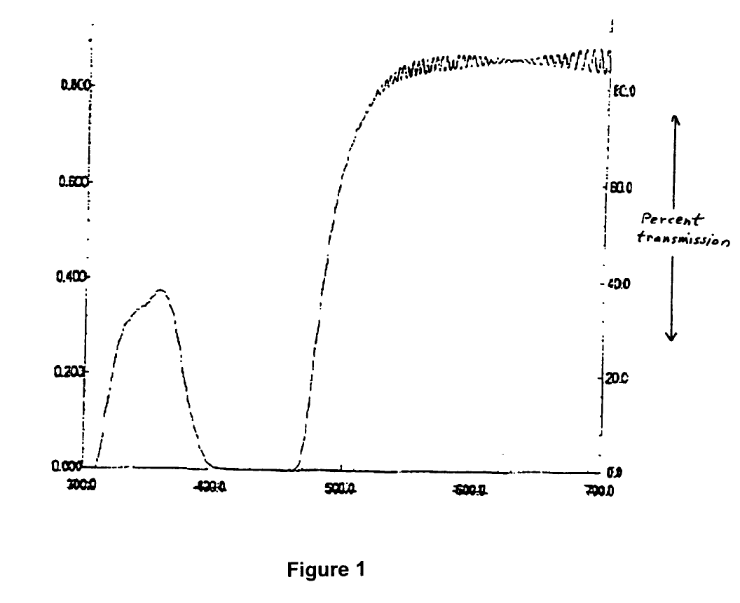

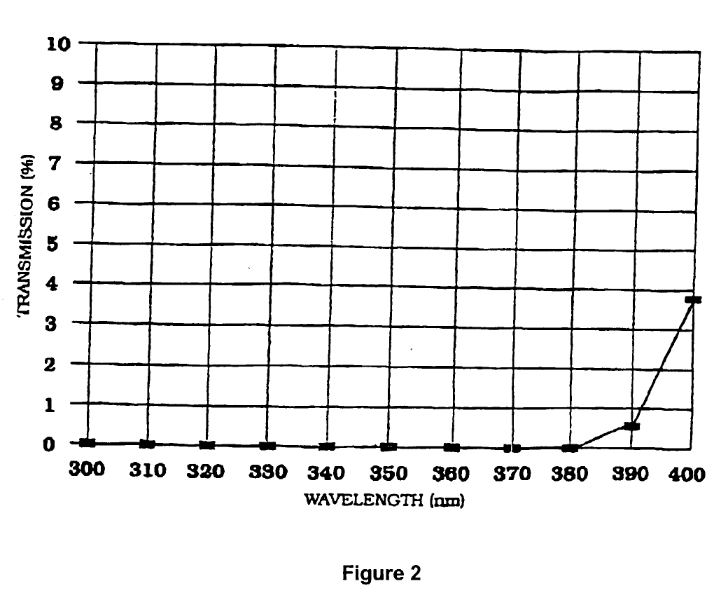

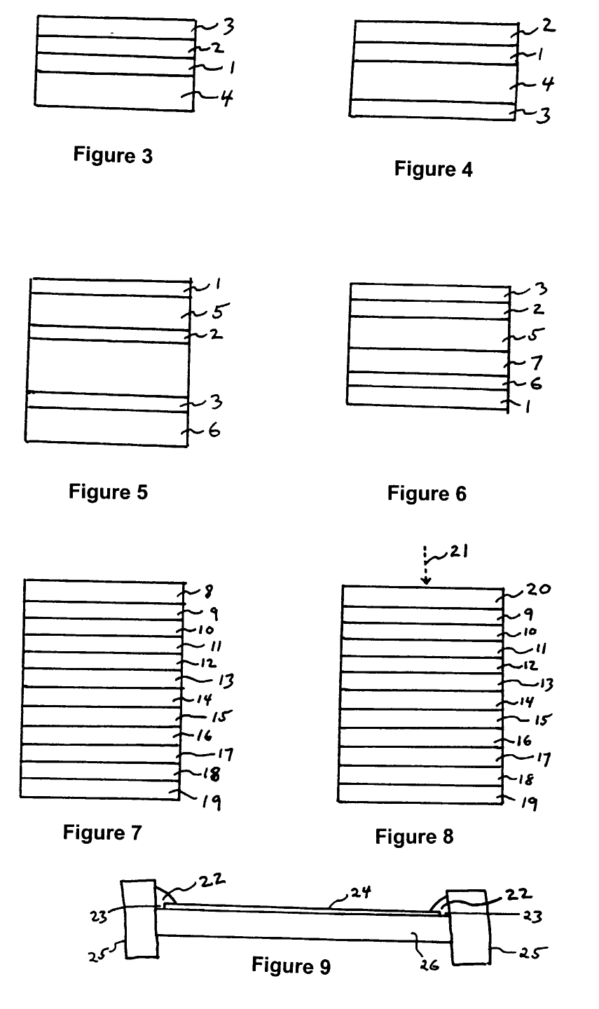

In one embodiment, the system and methods include a combination film illustrated in FIG. 3 consisting of a first layer 1, which is a standard yellow film layer having the wavelength transmission properties shown in FIG. 1 formed on a substrate 4 such as glass or acrylic; a second layer 2, which is a film layer having the wavelength transmission properties of FIG. 2 formed on the first layer; and a third film layer 3, having the electromagnetic filtering properties of the XIR 70 film shown in Table 1 below and an IR transmission at wavelengths between 780 nm and 2500 nm of no more than 50%, and preferably of less than 20%, and more preferably of about 15%, formed on the second layer. A film having the wavelength transmission properties shown in FIG. 1 is available from, for example, CPFilms as CPFilms Yellow Q2186 Film. An example of a film having the transmission properties of FIG. 2 is museum grade film manufactured by FTI Sun-Gard. An example of the third layer is the XIR 70 Film manufactured by Southwall Technologies. XIR 70 film is a well known component of a glass tint used in original equipment laminated automotive glass. Table 1 shows the characteristics of this type of tinted glass and, more particularly, Table 1 shows the properties of XIR 70 film, which is an example of the third layer of the present invention.

TABLE 1

| | | Visible Light | Visible | Total Solar | Solar | Relative Heat | |
|---|---|---|---|---|---|---|---|
| | Unit | Transmit- | Reflec-tance | Transmit- | Reflectance | Gain | Ultraviolet |
| Product/ | Thickness | tance (Tvis) | Exterior | tance (Tsol) | Exterior | Btu's/Hr/ | Blockage |
| Glass Type | Si | % | % | % | % | Ft² | % |
| Clear Glass | 4 mm | 90 | 9 | 81 | 8 | 220 | 30 |
| Standard Auto | 4 mm | 81 | 8 | 56 | 6 | 171 | 55 |
| Green Tint | | | | | | | |
| Spectrally | 4 mm | 74 | 7 | 44 | 5 | 150 | 70 |
| Absorbing Gree | | | | | | | |
| XIR 70 | 5 mm | 70 | 9 | 46 | 22 | 117 | >99 |
| XIR 75 | 5 mm | 75 | 11 | 52 | 23 | 135 | >99 |

Note:
XIR Glass construction is two plies of 2.1 mm clear glass with XIR-pvb interlayer.

Glass or a flexible transparent sheet having the first, second and third layers thereon, when used in the system and methods of the present invention is capable of at least 99% light rejection at up to at least 450 nanometers. In an alternative embodiment, the sequence of the first, second, and third film layers may be varied. Also, any of the film layers may be substituted by other films having similar transmission properties. In addition, the film layers may be overlaid or combined.

The first film layer noted above (e.g., the film having the properties shown in FIG. 1) absorbs selective wavelengths as illustrated in the graph, wherein the vertical axis on the right side of the figure shows the percent transmission while the vertical axis on the left side of the figure shows the corresponding decimal equivalent.

The second film layer (e.g., the film whose properties are shown in FIG. 2) exhibits an increasing percentage of light transmission beginning at about 380 nanometers as shown in FIG. 2. In one embodiment, the second film layer exhibits light transmission percentages for various wavelengths as shown below in Table 2.

TABLE 2

| Wavelength | Light Transmission |
|---|---|
| 320 nm | 0.1-0.3% |
| 380 nm | 0.4-0.5% |
| 400 nm | 3-5% |
| 500 nm | 85-88% |

The film having the properties shown in FIG. 2 and in table 2 may have a percent light transmission at 320 nm and 380 nm which is less than 1% of the transmission at 550 nm. In addition, the percent light transmission at 480 nm may be less than 50% of the transmission at 500 nm.

The third film layer (e.g., the film having similar properties to the XIR-70 film described in Table 1) has an IR transmission at wavelengths between 780 nm and 2500 nm of no more than 50%, preferably less than 20%, and more preferably about 15%. An example of the third film layer may be about 2 mils thick; have a visible light transmittance of about 60-70%; a visible reflectance (exterior) of about 9%; a total solar transmittance of about 46%; and a solar reflectance (exterior) of about 22%.

The embodiment of the invention which uses the first, second, and third film layers may produce a yellow cast due to the inclusion of the yellow film layer. This yellow cast is seen when looking from the inside toward the outside and is similar to the lighting in a shooting range or looking through night vision goggles. The exterior reflected color of the invention is not restricted, however, as a wide range of metallized products may be used in the mix to change the exterior appearance of the film. Testing has shown that different metallized versions of the invention can be made, and with the insertion of yellow, different colorations can be achieved.

As noted above, the light filters may be sequenced or distributed in any manner. FIG. 3 illustrates an embodiment wherein film layers 1, 2 and 3 (which are light filters) are connected to one side of substrate 4. FIG. 4 illustrates an alternative embodiment wherein film layers 1 and 2 are connected to one side of the substrate 4 while film layer 3 is connected to the other side of substrate 4. In a further embodiment illustrated in FIG. 5, the window glazing which serves as the substrate comprises two separate spaced-apart glass sheets 5 and 6. Film layers 1 and 2 are attached to either side of glass sheet 5 while film layer 3 is attached to glass sheet 6. Film layer 3 in FIG. 5 may be attached to either side of sheet 6. In a further embodiment illustrated in FIG. 6, the substrate upon which the films are connected may be a standard safety glass which includes PVB interlayer 7 interposed between glass sheets 5 and 6. Film layers 3 and 2 are connected to glass sheet 5 and film layer 1 is connected to glass sheet 6. It is also possible to connect any or all of film layers 1, 2 and 3 to PVB interlayer 7.

As also noted above, the light filters may be distributed on more than one surface. For example, film layers 2 and 3 may be connected to a window while film layer 1 is connected to a computer screen or other stand-alone device. Alternatively, film layers 1 and 2 may be connected to a computer screen or other stand-alone device, while film layer 3 is connected to a window.

In an alternative embodiment, film layers 1, 2, and/or 3 may be substituted by corresponding filters that meet the minimum filtering criteria of film layers 1, 2, and/or 3. In this alternative embodiment, one of the light filters may be a metal stack comprising a copper metal layer interposed between two nickel/chrome alloy layers. The nickel/chrome alloy layers may include a Hastelloy alloy or an Inconel alloy, which are well known to those skilled in the art. An example of a Hastelloy alloy includes Hastelloy C276, which has the characteristics shown in table 3.

TABLE 3

| | |
|---|---|
| Chemical composition, percent b | Coefficient of thermal expansion, |
| weight: C, 0.02^{a}, Mn, 1.00^{a}; Fe, | (70-200□F) in./in./° F. × 10⁶:6.2 |
| 5.50 S, 0.03^{a}; Si, 0.05^{a}; | Modus of elasticity, psi: tension, |
| Cr, 15.50; Ni, balance; Co, 2.50^{a}; | 29.8 × 10⁶ |
| Mo, 16.00; W, 3.75, V, 0.35^{a}; | Melting range, ° F.: 2,415-2,500 |
| P, 0.03^{a} Maximum | Specific heat, Btu/lb/° F., 70° F.: |
| Physical constants and thermal | 0.102 |
| properties | Thermal conductivity, Btu/ft²/hr/ |
| Density, lb/in.³:0.321 | in./° F., 70° F.: 69 |
| | Electrical resistivity, ohms/cmil/ft, |
| | 70° F.: 779 |
| | Heat Treatments |
| | Solution heat treat 2,100° F., |
| | rapid quench. |

TENSILE PROPERTIES
Solution Treated 2,100° F., Water Quench

| | | Y.S., psi, | Elong., in | Hardness, |
|---|---|---|---|---|
| Temperature, ° F. | T.S., psi | 0.2% offset | 2 in. % | Brinell |
| 70 | 113,500 | 52,000 | 70 | — |
| 400 | 101,700 | 44,100 | 71 | — |
| 600 | 95,100 | 39,100 | 71 | — |
| 800 | 93,800 | 33,500 | 75 | — |
| 1,000 | 89,600 | 31,700 | 74 | — |
| 1,200 | 86,900 | 32,900 | 73 | — |
| 1,400 | 80,700 | 30,900 | 78 | — |
| 1,600 | 63,500 | 29,900 | 92 | — |
| 1,800 | 39,000 | 27,000 | 127 | — |

Rupture Strength, 1,000 hr
Solution Treated, 2, 100° F., Water Quench

| Test Temperature, | | | Reduction of |
|---|---|---|---|
| ° F | Strength, psi | Elong., in 2 in., % | area, % |
| 1,200 | 40,000 | — | — |
| 1,400 | 18,000 | — | — |
| 1,600 | 7,000 | — | — |
| 1,800 | 3,100 | — | — |

Impact Strength
Solution Treated, 2, 100° F., Water Quench

| Test temperature, ° F. | Type test | Strength, ft-lb |
|---|---|---|
| −320 | Charpy-V-notched | 181 |
| +70 | Charpy-V-notched | 238 |
| +392 | Charpy-V-notched | 239 |

An example of an Inconel alloy includes Inconel 600 which has the characteristics shown in table 4.

TABLE 4

| | | |
|---|---|---|
| Chemical | Physical constants and | Thermal conductivity, |
| composition, | thermal properties | Btu/Ft²/hr/in./° F., 70° F.:1 |
| percent by | Density, lb/in.³:0.304 | Electrical resistivity, ohms/ |
| weight: C, 0.08; | Coefficient of thermal | cmil 70° F.: 620 |
| Mn, 0.5; Fe, 8.0; | expansion, (70-200° F. | Curie temperature, ° F.: |
| S, 0.008; Si, 0.25; | in./in./° F. × 10⁻⁶:7.4 | annealed 192 |
| Cr, 15.5; N, 76.0 | Modulus of elasticity, | Permeability (70° F., |
| Cu, 0.25; | psi: tension, 30 × 10⁶; | 200 Oe): annealed, 1.010 |
| Ti, 0.35; | torsion, 11 × 10⁶ | Heat treatments used in |
| Al, 0.25 | Poisson's ratio: 0.29 | annealed condition, |
| | Melting range, ° F.: | 1,850° F./30 min. |
| | 2,470-2,575 | |
| | Specific heat, Btu/lb/ | |
| | ° F., 70° F.: 0.106 | |

Tensile Properties
Hot Rolled

| | | Y.S., psi, | Elong., in | Hardness, |
|---|---|---|---|---|
| Temperature, ° F. | T.S., psi | 0.2% offset | 2 in. % | Brinell |
| 70 | 90,500 | 36,500 | 47 | — |
| 600 | 90,500 | 31,100 | 46 | — |
| 800 | 88,500 | 29,500 | 49 | — |
| 1,000 | 84,000 | 28,500 | 47 | — |
| 1,200 | 65,000 | 26,500 | 39 | — |
| 1,400 | 27,500 | 17,000 | 46 | — |
| 1,600 | 15,000 | 9,000 | 80 | — |
| 1,800 | 7,500 | 4,000 | 118 | — |

Rupture Strength, 1,000 hr.
Solution Annealed, 2,050° F./2 hr

| Test Temperature, | | | Reduction of |
|---|---|---|---|
| ° F. | Strength, psi | Elong., in 2 in., % | area, % |
| 1,500 | 5,600 | — | — |
| 1,600 | 3,500 | — | — |
| 1,800 | 1,800 | — | — |
| 2,000 | 920 | — | — |

Creep Strength (Stress, psi, to Produce 1% Creep)
Solution Annealed 2,050° F./2 hr.

| Test Temperature, ° F. | 10,000 hr | 100,000 hr |
|---|---|---|
| 1,300 | 5,000 | — |
| 1,500 | 3,200 | — |
| 1,600 | 2,000 | — |
| 1,700 | 1,100 | — |
| 1,800 | 560 | — |
| 2,000 | 270 | — |

Fatigue Strength
Annealed

| Test temperature, ° F. | Stress, psi | Cycles to failure |
|---|---|---|
| 70 | 39,000 | 10⁸ |

Impact Strength
Annealed

| Test temperature, ° F. | Type test | Strength, ft-lb |
|---|---|---|
| +70 | Charpy-V-notched | 180 |
| 800 | Charpy-V-notched | 187 |
| 1,000 | Charpy-V-notched | 160 |

Another light filter which may be used in this alternative embodiment includes a heat reflecting film. The heat reflecting film may be a sputtered metal/oxide stack described in U.S. Pat. No. 6,007,901 on a polyester (PET) film with UV absorbers dyed into it at 2.4 absorbance manufactured by the dyeing process described in U.S. Pat. No. 6,221,112. The disclosures of the aforementioned U.S. Pat. Nos. 6,007,901 and 6,221,112 are incorporated herein by reference. The aforementioned metal stack in combination with the sputtered metal/oxide stack produces a light filter which has the required characteristics of the XIR-70 film, and may therefore be substituted for the XIR-70 film.

A third light filter which may be used in this embodiment includes a 1.0 mil polyester (PET) film dyed yellow. This type of film is commercially available as Q2186 dark yellow. The film is manufactured by impregnating the polyester film with, for example, solvent dispersed yellow dye 54 or 64. The impregnation takes place utilizing 7 gms/liter loading. The film may be dyed using the process described in U.S. Pat. Nos. 3,943,105; 4,047,889; 4,055,971 or 4,115,054, the disclosures of which are incorporated herein by reference. The Q2186 dark yellow film is made with yellow dye 54, and is the same as the film of first layer 1 shown in FIG. 3.

The above-described light filters used in this embodiment may be connected to a substrate polyester film to produce the transparent flexible sheet as illustrated in FIG. 7.

Turning to FIG. 7, this embodiment of the invention includes layers 9-19 and optionally includes release liner layer 8, which is removed prior to application to the glass of a window, or to a screen, monitor, or other stand-alone device.

Release liner 8 may be a 1 mil polyester (PET) film with a silicone release coating on it. Any suitable silicone release coating may be used, such as a tin catalyzed silicone release which has about 10 grams per inch release characteristic. Non-silicone release formulations may be substituted for the silicone release layer.

Layer 9 may be a conventional pressure sensitive adhesive which holds the flexible sheet of FIG. 7 to the glass. An example of a pressure sensitive adhesive includes an acrylic solvent based pressure sensitive adhesive which is applied at about 10 lb./ream coat weight. The pressure sensitive adhesive of layer 9 may include 4% by weight of a UV absorber such as a benzotriazole UV absorber. Such a pressure sensitive adhesive is commercially available as National Starch 80-1057. Other adhesives or adhesive types may be substituted for the PSA adhesive as can other types of UV absorbers. It should be appreciated by one of ordinary skill in the art that these UV absorbers function as stabilizers, and may be added to the present invention to protect the adhesive from deterioration (e.g., deterioration caused by sunlight). These stabilizers, however, are not required to practice the invention.

Layer 10 may be a 0.5 mil. clear weatherable film. An example of layer 10 includes a polyester (PET) film with UV absorbers dyed into it at 2.4 absorbance. A suitable polyester film for layer 10 includes the film manufactured by the dyeing process described in U.S. Pat. No. 6,221,112. Other films with similar UV screening capability may be substituted for the above-described film used in layer 10.

Layer 11 may be a laminating adhesive which is used to laminate the layers together. A useful laminating adhesive includes any conventional polyester adhesive with an isocyanate cross-linker added thereto. An example of such a laminating adhesive is Rohm and Haas' Adcote 76R36 adhesive with catalyst 9H1H. The adhesive may be applied at 1-1.5 lb. per ream coat weight. Other laminating adhesives may be substituted for the above-noted polyester type adhesive.

Layer 12 may be a 1.0 mil. polyester (PET) film with sputtered heat reflecting, conductive metal stack coating made up of a copper layer interposed between 2 nickel/chrome alloy layers. Layer 12 has a visible light transmission of about 35%. The nickel/chrome alloy layers include Hastelloy C276 or Inconel 600. Specific examples of Hastelloy C276 and Inconel 600 are described below:

Hastelloy C276 having the following mechanical properties: UTI tensil psi: 106,000; yield psi: 43,000; elong % 71.0; and having the following chemical analysis:

HASTELLOY C 276

| element | % by weight |
|---|---|
| C | .004 |
| Fe | 5.31 |
| Mo | 15.42 |
| Mn | 0.48 |
| Co | 1.70 |
| C | 15.40 |
| S | .02 |
| S | .004 |
| P | .005 |
| W | 3.39 |
| V | 0.16 |
| Ni | Balance |

Inconel 600 having the following mechanical properties: UTI tensil psi: 139,500; yield psi 60,900; elong % 44.0; hardness: Rb85; and having the following chemical analysis:

INCONEL 600

| element | % by weight |
|---|---|
| C | .08 |
| Fe | 8.38 |
| Ti | 0.25 |
| Mn | 0.21 |
| Cu | 0.20 |
| Co | 0.05 |
| Cr | 15.71 |
| Si | 0.30 |
| S | <.001 |
| Al | 0.28 |
| P | 0.01 |
| Ni | 74.45 |
| Nb + Ta | 0.08 |

Layer 13 may be a laminating adhesive. The amount and type of laminating adhesive of layer 13 may be the same as the amount and type of laminating adhesive used in layer 11.

Layer 14 may be a heat reflecting film. The heat reflecting film of layer 14 may include a sputtered metal/oxide stack (described in U.S. Pat. No. 6,007,901) on a 1.0 mil clear weatherable polyester (PET) film. The polyester film has UV absorbers dyed into it at 2.4 absorbance. The film may be dyed using the dyeing process described in U.S. Pat. No. 6,221,112. Other films with UV screening capability may be used in place of the aforementioned UV screening film.

Layer 15 may be a laminating adhesive and may be the same as layers 11 and 13.

Layer 16 may be a 1.0 mil polyester (PET) film dyed yellow. An example of this film is known commercially as Q2186 dark yellow film. It is made by impregnating the polyester film with solvent dispersed yellow dye 54 or 64 at 7 grams/liter loading. The dyed polyester film is made by the procedures prescribed in U.S. Pat. Nos. 3,943,105; 4,047,889; 4,055,971 or 4,115,054.

Layer 17 may be a pressure sensitive adhesive. A suitable acrylic pressure sensitive adhesive includes Solutia's Gelva 263 which includes 8% by weight of a benzophenone type UV absorber. The pressure sensitive adhesive is coated at a rate of 4 lb. per ream coat weight.

Layer 18 includes a 7 mil polyester film which is utilized to provide a safety characteristic so that sharp glass fragments do not become dangerous projectiles when the glass breaks. Other thicknesses and/or types of films could be used.

Lastly, layer 19 may be a conventional hardcoat layer which is 1.0-2.0 microns thick. A suitable hardcoat composition includes the hardcoat described in U.S. Pat. No. 4,557,980; the disclosure of which is incorporated herein by reference.

The museum grade film, which may be utilized as one of the filters of this invention, includes a combination of filters comprising the dyed polyester film of layer 14 and the dyed polyester film of layer 10. Thus, the combination of these two dyed films used in the embodiments shown in FIGS. 7 and 8 is a functional equivalent of the museum grade film, and may be used as a substitute therefor.

The above-described film illustrated in FIG. 7 has numerous properties including UV, visible, IR, EMI and RFI shielding capability and has a safety characteristic which prevents flying glass injuries due to layer 18.

Turning to FIG. 8, this embodiment of the invention results from removing release liner 8 from the flexible sheet illustrated in FIG. 7, thereby allowing the remaining layers 9-19 to be attached to the glass or other surface of a window or to a screen, monitor or other stand-alone device. FIG. 8 includes glass substrate 20 connected to the sheet illustrated in FIG. 7. When the present invention is applied to a window, the sheet of FIG. 7 may be adhered to the surface of the glass portion of the window which faces the inside of the room so that layer 18 can provide the desired safety feature described above. The side of the glass which faces the interior of the room is the side of the glass opposite to the side which receives sunlight from the direction shown by arrow 21 in FIG. 8.

The combination of light filters used in this invention has a shielding effectiveness of 22 db-40 db in the frequency range of 30 megahertz to 3 gigahertz, an IR transmission at wavelengths between 780 nm and 2500 nm of no more than 50%, preferably less than 20%, more preferably about 15%, and a light transmission which is less than 1%, and preferably less than 0.1%, for wavelengths of 450 nm and less. In one embodiment, the combination of light filters has the properties shown in Table 5.

TABLE 5

| Shielding Effectiveness in the frequency range | 22 db-40 db |
|---|---|
| of 30 megahertz - 3 gigahertz | |
| Light transmission @ 450 nm | <1% |
| IR transmission | <50% |
| Emittance | 0.81 |
| % Solar Transmittance | 13 |
| % Solar Absorption | 59 |
| % Visible Transmittance | 25 |
| % Reflectance | 22 |
| % UV Transmittance | 0.01 |
| Solar Heat Gain Co-efficient | 0.30 |
| U Factor | 1.09 |
| Shading Coefficient | 0.34 |
| % Solar Energy Rejected | 70 |

It should be apparent to one of ordinary skill in the art, however, that the properties shown in Table 5 may vary according to the filter layers employed, although shielding effectiveness, IR transmission, and light transmission properties should preferably remain constant.

In a further embodiment of the present invention, the combination of light filters has the properties shown in Table 6.

TABLE 6

| | |
|---|---|
| UV-transmission @ 380 nm | <0.1% |
| UV-Vis transmission from 380 to 450 nm | <2% |
| Visible transmission from 450-470 nm | <5% |
| Visible transmission from 470-780 nm | >1% |
| Near IR transmission at 900 nm | <10% |
| Near IR transmission at 1060 nm | <5% |
| Near IR transmission at 780 nm-1100 nm | <20% |
| Near IR transmission at 1150 nm | <5% |
| Near IR transmission at 1300 nm | <3% |
| Near IR transmission at 1550 nm | <2% |
| IR transmission at 1100-2500 nm | <5% |
| Conductivity | <7 ohms per square |
| Shielding effectiveness for 30 megahertz - 3 | 22 db-40 db |
| gigahertz | |

A flexible transparent sheet made in accordance with this invention may also be used to minimize acoustic transmissions from a building by carefully applying the film to the window with an adhesive while making certain that no visible air bubbles are formed between the flexible sheet and the glazing of the window. The term “visible air bubbles” used herein means air bubbles which are visible without any magnification (ie., visible to the naked eye). It has been discovered that when the transparent flexible sheet lies over an air bubble, the flexible sheet behaves like the diaphragm of a loudspeaker. This causes unwanted transmission of sound waves. Avoiding these bubbles minimizes the transmission of the sound waves through the window.

The combination of filters used in this invention should cover the surface area of the entire window glazing to minimize the passage of the selected wavelengths there-through. Thus, when the filters are applied to the glazing by adhering a flexible transparent sheet thereto, the flexible transparent sheet having the light filters thereon should be carefully positioned so that there are no gaps or unprotected areas on the glazing. In an embodiment, a single transparent flexible sheet having the filters thereon is employed to avoid seams between the edges of the flexible sheets on the glazing of a window. The avoidance of seams is beneficial because seams allow leakage of the wavelengths which the present invention seeks to avoid. This leakage through the seams occurs even when the edges of the flexible sheets are butted against one another and even when the edges overlap one another.

There is also a potential for leakage of the wavelengths around the periphery of the flexible sheet adjacent to the window frame. Turning to FIG. 9, leakage around the periphery may be minimized by applying an opaque electrically conductive sealant 22 around the periphery so that any gap 23 between the sheet 24 and the window frame 25 may be masked by the sealant. Thus, the sealant would cover any exposed portions of the glazing not covered by the sheet. FIG. 9 illustrates sheet 24 adhered to glazing 26 of a standard window. The sealant may be neutral curing to avoid unwanted chemical interaction with the sheet. An example of suitable sealant includes a silicone elastomer, such as Dow Corning 995 Silicone Structural Adhesive.

Although the present invention has been described in terms of certain preferred embodiments, one skilled in the art will readily appreciate that various modifications, changes, omissions and substitutions may be made without departing from the spirit thereof. Thus, it is intended, therefore, that the present invention covers the modifications and variations of the invention provided they come within the scope of any claims and their equivalents.

1. A transparent anti-surveillance security system comprising:
a transparent substrate; and
a combination of filters connected to said substrate, the combination of filters being selected and configured to filter the passage of selected electromagnetic wavelengths through the system, and having a shielding effectiveness which attenuates the transmission of radio frequency wavelengths there-through, an IR transmission at wavelengths between 780 nm and 2500 nm of no more than 50%, and a light transmission of less than 1% for wavelengths up to 450 nm.

2. The anti-surveillance security system according to claim 1, which has a shielding effectiveness between 22 db-40 db in the frequency range of 30 megahertz-3 gigahertz.

3. The anti-surveillance security system according to claim 2, wherein the IR transmission at wavelengths between 780 nm and 2500 nm is less than 20%.

4. The anti-surveillance security system according to claim 2, wherein the IR transmission at wavelengths between 780 nm and 2500 nm is less than or equal to approximately 15%.

5. The anti-surveillance security system according to claim 2, wherein the combination of filters have a light transmission less than 0.1% for wavelengths up to 380 nm.

6. The system according to claim 2, wherein the combination of filters have the following properties:

| | |
|---|---|
| IR Transmission | <20% |
| Emittance | 0.81 |
| % Solar Transmittance | 13 |
| % Solar Absorption | 59 |
| % Visible Transmittance | 25 |
| % Reflectance | 22 |
| % UV Transmittance | 0.01 |
| Solar Heat Gain Co-efficient | 0.30 |
| U Factor | 1.09 |
| Shading Coefficient | 0.34 |
| % Solar Energy Rejected | 70 |

7. The system according to claim 2, wherein the combination of filters have the following properties:

| | |
|---|---|
| UV-transmission @ 380 nm | <0.1% |
| UV-Vis transmission from 380 to 450 nm | <2% |
| Visible transmission from 450-470 nm | <5% |
| Visible transmission from 470-780 nm | >1% |
| Near IR transmission at 900 nm | <10% |
| Near IR transmission at 1060 nm | <5% |
| Near IR transmission at 780 nm-1100 nm | <20% |
| Near IR transmission at 1150 nm | <5% |
| Near IR transmission at 1300 nm | <3% |
| Near IR transmission at 1550 nm | <2% |
| IR transmission at 1100-2500 nm | <5% |
| Conductivity | <7 ohms per square |
| Shielding effectiveness for 30 megahertz - 3 | 22 db-40 db |
| gigahertz | |

8. The system of claim 2, wherein the substrate includes a flexible transparent plastic sheet configured for attachment to glazing of a window.

9. The system of claim 2, wherein the substrate comprises glazing of a window.

10. The system of claim 8 further including a window, the flexible transparent plastic sheet being adhered to glazing of the window.

11. The system of claim 2, wherein the substrate includes a flexible transparent sheet configured for attachment to at least one of a screen, monitor, and other stand-alone devices.

12. The system of claim 10, wherein the flexible transparent sheet includes a single sheet configured to cover the glazing; and the system further includes an opaque electrically conductive sealant applied so as to cover any exposed portions of the glazing not covered by the sheet.

13. The system of claim 8 wherein the combination of filters are in the form of layers connected to the plastic sheet.

14. The system of claim 13 wherein an adhesive layer connects the plastic sheet to the glazing.

15. The system of claim 14 wherein visible air bubbles are excluded between the plastic sheet and the glazing.

16. The system of claim 9 wherein the combination of filters are in the form of layers connected to the glazing of the window.

17. A transparent anti-surveillance security system comprising:
a transparent substrate; and
a combination of filters connected to the substrate, the combination of filters being selected and configured to filter passage of selected electromagnetic wavelengths through the system, the combination of filters comprising:
a first filter having the light transmission properties shown in FIG. 1;
a second filter having the light transmission properties shown in FIG. 2; and
a third filter having an IR transmission at wavelengths between 780 nm and 2500 nm of no more than 50%.

18. The anti-surveillance security system according to claim 17, wherein the IR transmission at wavelengths between 780 nm and 2500 nm is less than 20%.

19. The anti-surveillance security system according to claim 17, wherein the IR transmission at wavelengths between 780 nm and 2500 nm is less than or equal to approximately 15%.

20. The system of claim 17, wherein the second filter exhibits the following wavelength-light transmission characteristics:

| Wavelength | Light Transmission |
|---|---|
| 320 nm | 0.1-0.3% |
| 380 nm | 0.4-0.5% |
| 400 nm | 3-5% |
| 500 nm | 85-88% |

21. The system of claim 17, wherein the second filter exhibits a percent light transmission at 320 nm and 380 nm which is less than 1% of the transmission at 550 nm, and a percent light transmission at 400 nm which is less than 50% of the transmission at 550 nm.

22. The system according to claim 17, wherein the third filter exhibits a visible light transmittance of about 60-70%, a visible reflectance of about 9%, a total solar transmittance of about 46%, and a solar reflectance of about 22%.

23. The system of claim 17 wherein the substrate includes a flexible transparent plastic sheet configured for attachment to glazing of a window.

24. The system of claim 17 wherein the substrate includes a flexible transparent plastic sheet configured for attachment to at least one of a monitor, screen, and other stand-alone devices.

25. The system of claim 17 wherein the substrate comprises glazing of a window.

26. The system of claim 23 further including a window, the flexible transparent plastic sheet being attached to glazing of said window.

27. The system of claim 26 wherein the flexible transparent sheet includes a single sheet configured to cover said glazing; and the system further includes an opaque electrically conductive sealant applied so as to cover any exposed portions of the glazing not covered by the sheet.

28. The system of claim 23 wherein the combination of filters are in the form of layers connected to the plastic sheet.

29. The system of claim 28 wherein an adhesive layer connects the plastic sheet to the glazing.

30. The system of claim 29 wherein visible air bubbles are excluded between the plastic sheet and the glazing.

31. The system of claim 25 wherein the combination of filters are in the form of layers connected to the glazing of the window.

32. An anti-surveillance security system comprising a flexible transparent sheet which includes the following sequence of layers:
an outer pressure sensitive adhesive for adhering the sheet to at least one of a window, screen, monitor and other stand-alone device;
a plastic film with Uv absorbers therein;
a laminating adhesive;
a plastic film having a heat reflecting conductive stack coated thereon, the stack comprising a copper layer interposed between two nickel-chrome alloy layers, and exhibiting a visible light transmission of about 35%;
a laminating adhesive;
a heat reflecting film having a metal/oxide stack coated thereon, the heat reflecting film having UV absorbers contained therein;
a laminating adhesive;
a plastic film having yellow dye impregnated therein;
a pressure sensitive adhesive;
a safety film; and
a hardcoat for protecting the surface of said sheet.

33. The system of claim 32 further including a release liner releasably secured to the outer pressure sensitive adhesive so that the sheet can be adhesively secured to the glazing of the window upon removal of the release liner.

34. The system of claim 33 further being secured to a glazing of a window by the outer pressure sensitive adhesive.

35. A method for filtering electromagnetic, visual, and minimizing acoustic transmissions, comprising:
selecting a transparent substrate; and
configuring a combination of filters connected to the substrate for filtering passage of the transmissions as measured by a shielding effectiveness between 22 db-40 db over 30 megahertz-3 gigahertzan IR transmission at wavelengths between 780 nm and 2500 nm of no more than 50%, and a light transmission of less than 1% for electromagnetic wavelengths up to at least 450 nm.

36. The method according to claim 35, wherein the IR transmission at wavelengths between 780 nm and 2500 nm is less than 20%.

37. The method according to claim 35, wherein the IR transmission at wavelengths between 780 nm and 2500 nm is less than or equal to approximately 15%.

38. A transparent anti-surveillance security system comprising a transparent substrate and a combination of filters connected to the substrate; the combination of filters being selected and configured to filter passage of selected electromagnetic wavelengths through the system, the combination of filters comprising:
a first filter having the electromagnetic filtering properties of a 1.0 mil. polyester (PET) film dyed yellow;
a second filter having the electromagnetic filtering properties of a 0.5 mil. clear weatherable film and a heat reflecting film; and
a third filter having the electromagnetic filtering properties of a 1.0 ml. polyester (PET) film with sputtered heat reflecting, conductive metal stack coating made up of a copper layer interposed between 2 nickel/chrome alloy layers.
